(19) United States
(12) Patent Application Publication
(10) Pub. No.: US 2004/0004312 A1
(43) Pub. Date: Jan. 8, 2004

(54) Process of over moulding

(75) Inventor: Mathew Varghese Kaye, Worcs. (GB)

Correspondence Address: BANNER & WITCOFF, LTD., 28 STATE STREET, 28th FLOOR, BOSTON, MA, 02109-9601, US

(73) Assignee: Brandenburg UK Limited, West Midlands (GB)

(21) Appl. No.: 10/420,455

(22) Filed: Apr. 22, 2003

(30) Foreign Application Priority Data
Apr. 22, 2002 (GB) 0209114.8

(51) Int. Cl. B29C 70/28; B29C 70/74

(52) U.S. Cl. 264/511; 425/110; 425/104; 425/DIG. 60

(57) ABSTRACT

A process for the production of an over moulded substrate is provided together with an apparatus suitable for use in the process. The process comprises the steps of:

(a) picking up a substrate (1) by means of one or more sets of vacuum suckers (4);

(b) placing the substrate (1) into an over moulding tool;

(c) holding the substrate (1) in position in the over moulding tool by means of one or more sets of vacuum suckers (8); and

(d) over moulding a plastics material onto the substrate (1) whilst maintaining most or all of the substrate (1) at a temperature of 80° C. or less.

The present invention relates to an improved process of over moulding plastics material onto a substrate.

The technique of over moulding, or insert moulding, is well known as a method of moulding a plastics material onto a substrate. For example, over moulding is known as a way of moulding plastics material onto the edges of a substrate so as to produce a border around the substrate, which can be used to allow the substrate to be handled more easily.

However, there are a number of problems associated with the technique of over moulding as currently used to apply a border of plastics material to a substrate. The technique requires high temperatures to be used, often above 250° C., in order to mould the plastics material onto the substrate. This high temperature can unduly affect the properties of the substrate and can also lead to deformation of the substrate, which is clearly undesirable.

Further, during the process of over moulding as currently used there can be inconsistent shrinkage between the substrate and the over moulded plastics material. There can also be difficulties encountered in picking up the substrate in a vertical alignment from the loading area without alteration, in placing the substrate precisely in the moulding tool whilst the machine is shutting and moulding and in ensuring that the over moulded substrate is removed from the moulding tool without distortion and stress.

Accordingly, there is a need for an improved process for the production of over moulded substrates.

The present invention provides a process for the production of an over moulded substrate which process comprises the steps of:

(a) picking up a substrate by means of one or more sets of vacuum suckers;

(b) placing the substrate into an over moulding tool;

(c) holding the substrate in position in the over moulding tool by means of one or more sets of vacuum suckers; and

(d) over moulding a plastics material onto the substrate whilst maintaining most or all of the substrate at a temperature of 80° C. or less.

Preferably in step (d) the substrate is maintained at a temperature of 60° C. or less, more preferably 50° C. or less, for example 48° C. or less. The substrate may be maintained at a suitable temperature by a cooling system, for example a cooling system located on one side of the substrate or a cooling system located on two opposite sides of the substrate.

Preferably, the process includes a step before step (a) of loading the substrate onto a loader, for example a magazine loader, from which the substrate is subsequently picked up.

It is preferred that the process includes a step after step (d) of removing the over moulded substrate from the over moulding tool by means of one or more sets of vacuum suckers, for example by means of a pick up plate provided with a one or more sets of vacuum suckers.

Preferably, one or more of steps (a) to (d) of the process are automated. More preferably, all of steps (a) to (d) are automated. Most preferably, the process of the present invention is fully automated.

It is preferred that the process is a continuous process that allows for the over moulding of substrates to be carried out continuously over a given period of time.

Preferably, one or more of the sets of vacuum suckers used in the process are, in use, located towards the outer edges of the substrate. Preferably, all of the sets of vacuum suckers used in a given step of the process are located towards the outer edges of the substrate when in use. More preferably, all of the sets of vacuum suckers used throughout the process are in use located towards the outer edges of the substrate.

It is further preferred that in each step of the process there are four sets of vacuum suckers arranged in a rectangular configuration. It is most preferred that the substrate is substantially rectangular in shape and that in each step of the process there is a set of vacuum suckers located close to each of the four corners of the substrate. It is also preferred that each set of vacuum suckers used throughout the process has three or more vacuum suckers, for example five vacuum suckers.

Suitable techniques may be employed, if required, to assist in the accurate positioning of the substrate in the machinery used in the process of the present invention. For example, a locator may be included in the substrate or suitable robotics may be used.

In a preferred embodiment, the process of the present invention comprises the steps of:

1. loading a substrate into a magazine loader;

2. picking up the substrate from the magazine loader by means of a pick up plate having four sets of vacuum suckers in a rectangular configuration, whereby the vacuum suckers attach to a first face of the substrate, with each set of vacuum suckers being located close to an edge of the face;

3. placing the substrate into an over moulding tool;

4. holding the substrate in position in the over moulding tool by means of four sets of vacuum suckers in a rectangular configuration provided on the moulding tool, whereby the vacuum suckers attach to a second face of the substrate, with each set of vacuum suckers being located close to an edge of the face;

5. over moulding a plastics material onto the outer edges of the substrate whilst maintaining the area of the substrate within the rectangle defined by the four sets of vacuum suckers at a temperature of 60° C. or less, for example, 48° C. or less; and

6. removing the over moulded substrate from the over moulding tool by means of a pick up plate having four sets of vacuum suckers in a rectangular configuration, whereby the vacuum suckers attach to a first face of the substrate, with each set of vacuum suckers being located close to an edge of the face.

The present invention also provides an apparatus suitable for use in a process for over moulding a substrate, such as the process of the present invention, which apparatus comprises, in association, a pick up plate and an over moulding tool, whereby the pick up plate is provided with a one or more sets of vacuum suckers for picking up the substrate and the over moulding tool is provided with a one or more sets of vacuum suckers for holding the substrate in place during the over moulding and with a cooling system for maintaining the temperature of most or all of the substrate at 80° C. or less, preferably 60° C. or less, during the over moulding.

Preferably, there are four sets of vacuum suckers provided on the pick up plate, arranged in a rectangular configuration. It is preferred that the over moulding tool is provided with four sets of vacuum suckers arranged in a rectangular configuration.

It is preferred that the cooling system of the over moulding tool operates by flowing cold water adjacent to the substrate in order to maintain the substrate at 80° C. or less. It is preferred that the cooling system is arranged such that at least the area of the substrate within the rectangle defined by the four sets of vacuum suckers is maintained at a temperature of 80° C. or less. The cooling system of the over moulding tool may be located on one side or on two opposite sides of the substrate.

The apparatus preferably further comprises a loader, such as a magazine loader, from which the pick up plate can pick up the substrate.

The process and apparatus of the present invention may suitably be used to over mould a plastics frame around the outer edges of a glue board. Such a plastics frame may allow the glue board to be easily inserted and fixed in position in an insect trap, for example a mosquito trap. Such traps may be conventional traps for the capture and killing of insects or may be monitoring traps which catch insects so as to monitor the insect population in a given area.

The process of the present invention allows a plastics frame to be over moulded onto a glue board without unduly affecting the adhesive properties of the glue board, as the glue board is maintained at 80° C. or less during the over moulding process. Further, deformation of the glue board during the over moulding process and inconsistent shrinkage between the glue board and the plastics frame are avoided.

An embodiment of the present invention will now be described with reference to the drawings in which:

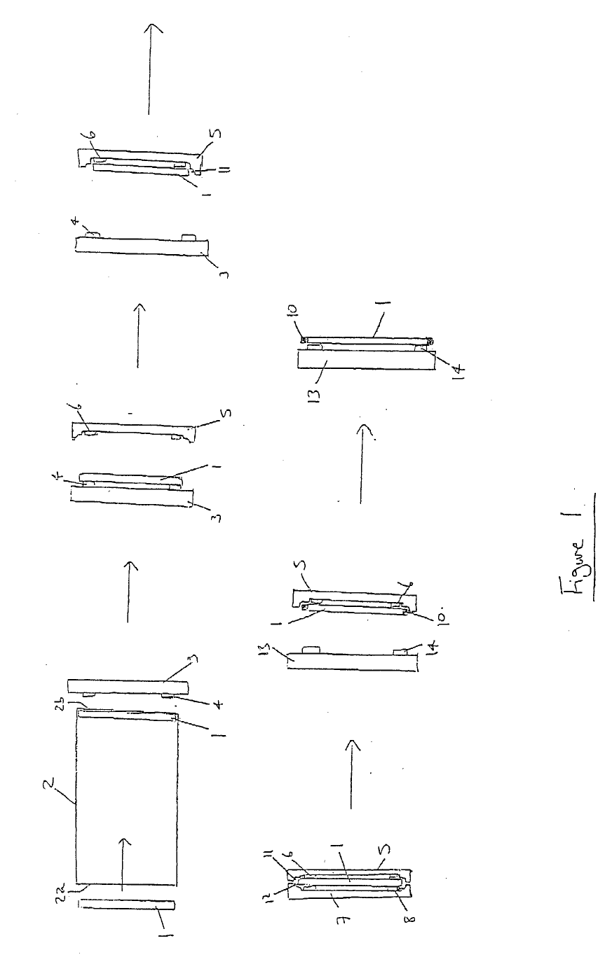

FIG. 1 is a diagram showing schematically a process of the present invention in which a plastics frame is over moulded onto a glue board; and

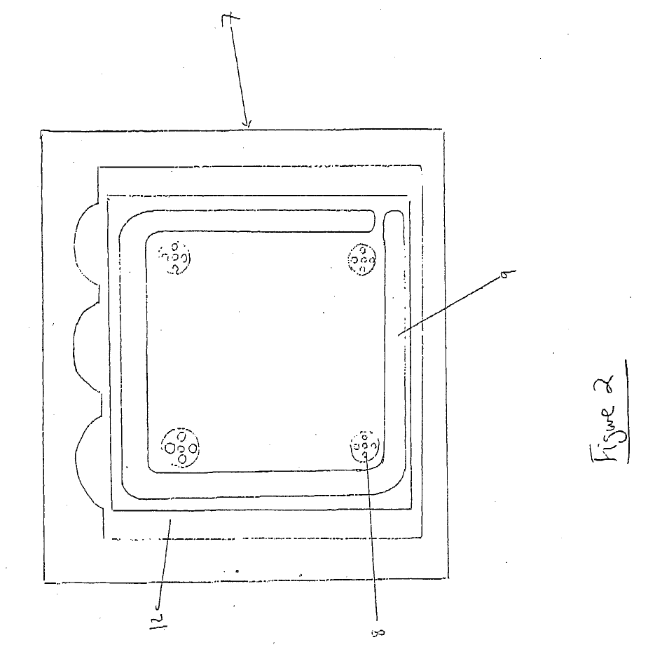

FIG. 2 is a diagram showing a movable half of the die plate which holds the glue board in the over moulding tool used in the process shown in FIG. 1.

A process for the production of an over moulded glue board in accordance with the present invention comprises the steps of:

A. loading a rectangular glue board 1 into a magazine loader 2 through an entrance 2a of the magazine loader, such that the two longer edges of the glue board 1 are vertical and the two shorter edges of the glue board 1 are horizontal, and a front face of the glue board 1 provided with a release paper covering the adhesive of the glue board faces an exit 2b of the magazine loader;

B. moving the glue board 1 through the magazine loader 2 from the entrance 2a towards the exit 2b by means of a spring and pulley system;

C. picking up the glue board 1 from the exit 2b of the magazine loader 2 by means of a robotic pick up plate 3 having four sets of vacuum suckers 4 in a rectangular configuration, whereby the vacuum suckers 4 attach to the front face of the glue board 1, with a set of vacuum suckers 4 close to each corner of the face;

D. moving the robotic pick up plate 3 and the attached glue board 1 towards an over moulding tool and placing the glue board into a substrate receiving section of the over moulding tool;

E. attaching the glue board 1 to a fixed half 5 of a die plate of the over moulding tool by means of four sets of vacuum suckers 6 in a rectangular configuration on the fixed half 5 of the die plate, whereby the vacuum suckers 6 attach to the back face of the glue board 1, with a set of vacuum suckers 6 close to each corner of the face, with the fixed half 5 of the die plate having a shaped cavity 11;

F. removing the pick up plate 3 from the front face of the glue board 1;

G. attaching the glue board 1 to a movable half 7 of the die plate of the over moulding tool by means of four sets of vacuum suckers 8 in a rectangular configuration on the movable half 7 of the die plate, whereby the vacuum suckers 8 attach to the front face of the glue board 1, with a set of vacuum suckers 8 close to each corner of the face, with the moveable half 7 of the die plate being provided with a shaped cavity 12 which together with shaped cavity 11 of the fixed half 5 of the die cast corresponds to the shape of the over moulding required;

H. over moulding a plastics material onto the outer edges of the glue board 1 to form a frame 10 in the shape of the cavity provided in the die cast whilst maintaining most or all of the front and back faces of the glue board 1 at a temperature of 48° C. or less by means of a cooling system 9 located on one or both of the movable half 7 and the fixed half 5 of the die plate which flows cold water adjacent to both the front and the back face of the glue board 1;

I. removing the movable half 7 of the die plate from the glue board 1; and

J. removing the over moulded glue board 1 from the over moulding tool by means of a robotic pick up plate 13 having four sets of vacuum suckers 14 in a rectangular configuration, whereby the vacuum suckers 14 attach to the front face of the glue board 1, with a set of vacuum suckers 14 close to each corner of the face,

This process allows the production of a glue board having a plastics frame without adversely affecting the properties of the glue board, in particular the properties of the adhesive. The frame can then be used to facilitate movement of the glue board and to hold the glue board in position, in particular in an insect trap, such that its required position is maintained under varying environmental conditions.

1. A process for the production of an over moulded substrate which process comprises the steps of:
(a) picking up a substrate by means of one or more sets of vacuum suckers;
(b) placing the substrate into an over moulding tool;
(c) holding the substrate in position in the over moulding tool by means of one or more sets of vacuum suckers; and
(d) over moulding a plastics material onto the substrate whilst maintaining most or all of the substrate at a temperature of 80° C. or less.

2. A process according to claim 1 wherein in step (d) most or all of the substrate is maintained at a temperature of 60° C. or less.

3. A process according to claim 2 wherein in step (d) most or all of the substrate is maintained at a temperature of 50° C. or less.

4. A process according to claim 3 wherein in step (d) most or all of the substrate is maintained at a temperature of 48° C. or less.

5. A process according to any one of the preceding claims wherein the temperature of most or all of the substrate is maintained in step (d) by a cooling system located on one side of the substrate or a cooling system located on two opposite sides of the substrate.

6. A process according to any one of the preceding claims which includes a step before step (a) of loading the substrate onto a loader from which the substrate is subsequently picked up.

7. A process according to any one of the preceding claims which includes a step after step (d) of removing the over moulded substrate from the over moulding tool by means of one or more sets of vacuum suckers.

8. A process according to any one of the preceding claims wherein one or more of steps (a) to (d) of the process are automated.

9. A process according to any one of the preceding claims wherein the process is fully automated.

10. A process according to any one of the preceding claims wherein the process is a continuous process that allows for the over moulding of substrates to be carried out continuously over a given period of time.

11. A process according to any one of the preceding claims wherein one or more of the sets of vacuum suckers used in the process are, in use, located towards the outer edges of the substrate.

12. A process according to any one of the preceding claims wherein in each step of the process there are four sets of vacuum suckers arranged in a rectangular configuration.

13. A process according to claim 12 wherein the substrate is substantially rectangular in shape and in each step of the process there is a set of vacuum suckers located close to each of the four corners of the substrate.

14. A process according to any one of the preceding claims wherein each set of vacuum suckers used throughout the process has three or more vacuum suckers.

15. A process according to claim 1, which process comprises the steps of:
1. loading a substrate into a magazine loader;
2. picking up the substrate from the magazine loader by means of a pick up plate having four sets of vacuum suckers in a rectangular configuration, whereby the vacuum suckers attach to a first face of the substrate, with each set of vacuum suckers being located close to an edge of a face;
3. placing the substrate over into an over moulding tool;
4. holding the substrate in position in the over moulding tool by means of four sets of vacuum suckers in a rectangular configuration provided on the moulding tool, whereby the vacuum suckers attach to a second face of the substrate, with each set of vacuum suckers being located close to an edge of the face;
5. over moulding a plastics material onto the outer edges of the substrate whilst maintaining the area of the substrate within the rectangle defined by the four sets of vacuum suckers at a temperature of 60° C. or less; and
6. removing the over moulded substrate from the over moulding tool by means of a pick up plate having four sets of vacuum suckers in a rectangular configuration, whereby the vacuum suckers attach to a first face of the substrate, with each set of vacuum suckers being located close to an edge of the face.

16. A process according to claim 15, wherein in step 5 the area of the substrate defined by the four sets of vacuum suckers is maintained at a temperature of 48° C. or less.

17. Apparatus suitable for use in a process for over moulding a substrate, which apparatus comprises, in association, a pick up plate and an over moulding, tool, whereby the pick up plate is provided with one or more sets of vacuum suckers for picking up the substrate and the over moulding tool is provided with one or more sets of vacuum suckers for holding the substrate in place during the over moulding and with a cooling system for maintaining the temperature of most or all of the substrate at 80° C. or less during the over moulding.

18. Apparatus according to claim 17, wherein four sets of vacuum suckers are provided on the pick up plate, arranged in a rectangular configuration.

19. Apparatus according to claim 17 or claim 18 wherein the over moulding tool is provided with four sets of vacuum suckers arranged in a rectangular configuration.

20. Apparatus according to claim 18 or claim 19 wherein the cooling system is arranged such that at least the area of the substrate within the rectangle defined by the four sets of vacuum suckers is maintained at a temperature of 80° C. or less.

21. Apparatus according to any one of claims 17 to 20 wherein the cooling system of the over moulding tool operates by flowing cold water adjacent to the substrate in order to maintain most or all of the substrate at 80° C. or less.

22. Apparatus according to any one of claims 17 to 21 which further comprises a loader from which the pick up plate can pick up the substrate.

23. Use of a process according to any one of claims 1 to 16 or apparatus according to any one of claims 17 to 22 to over mould a plastics frame around the outer edges of a glue board.

24. A process for the production of a over moulded substrate substantially as hereinbefore described.

25. Apparatus suitable for use in a process for offer moulding a substrate substantially hereinbefore described and with reference to the drawings.
